(19) United States
(12) Patent Application Publication
(10) Pub. No.: US 2024/0002013 A1
(43) Pub. Date: Jan. 4, 2024

(54) CRANK WITH ADJUSTABLE BEARING HANDLE AND ADAPTER

(71) Applicant: AMERICAN INNOVATOR LLC, Powderly, TX (US)

(72) Inventors: Jared Kornelsen, Fountain, CO (US); Branton Loewen, Powderly, TX (US)

(21) Appl. No.: 18/030,233

(22) PCT Filed: Oct. 5, 2021
(86) PCT No.: PCT/US21/53672

§ 371 Date: Apr. 4, 2023

Related U.S. Application Data
(60) Provisional application No. 63/087,874, filed on Oct. 6, 2020.

(51) Int. Cl. B62M 3/02; G05G 1/08; B66F 13/00

(52) U.S. Cl. CPC B62M 3/02; G05G 1/085; B66F 13/00

(57) ABSTRACT

A crank assembly with an adjustable handle assembly that includes a handle mounted on bearings and on an axle such as a self-locking, quick-release pin. The pin allows the handle assembly to be removably positioned in any of a number of holes in the crank body allowing choice of high leverage or high speed during crank operation. While designed with hand-cranked trailer jacks in mind, the crank assembly can be used in various applications requiring hand cranking by suitable choice of crank interface and dimensions. An adapter at the crank interface may be used alone with a power drive tool or by hand with the crank assembly.

### BACKGROUND OF THE INVENTION

This invention relates generally to a crank assembly with a repositionable, bearing handle and an associated adapter.

In the trailer industry most jack cranks are non-adjustable and feature metal handles that are crimped onto the metal crank tube resulting in the handle often seizing on the metal-on-metal design of the crank. Furthermore, most jack crank handles are not sealed and are open to the weather elements resulting in many being seized and rusted. In this situation the operator must grip the handle and while rotating the crank have the handle not spin on the crank body but instead let it spin in their hand, this results in unwanted friction and physical exertion needed to operate the crank.

U.S. Pat. No. 8,032,999 describes one attempt at a solution for cranks that are susceptible to rust and seizing up, resulting in difficult operation. The described solution is to use an aluminum shaft pressed into a plastic tube as a handle. The plastic used is Delrin®, an acetal homopolymer from DuPont. Limitations of this approach include wear since plastic is not as resistant to physical abuse as a metal handle, problems from foreign material entering the space between the plastic and aluminum, and design limitations such as limited texturing options.

### SUMMARY OF THE INVENTION

The present invention is directed to systems and methods which provide an adjustable crank with a durable bearing handle which can expedite crank operation, operate smoothly, be sealed to weather, and be flexible with respect to design options.

The invention is directed to a crank assembly including an L-shaped crank body with a shorter end and a longer end; a crank interface attached to the shorter end; and one or more handle-attachment points on the longer end. A crank handle assembly includes an axle; one or more bearings mountable on the axle and a handle mountable over the bearings; so that the crank handle assembly is removably positionable at any of the handle-attachment points for operation of the crank assembly to turn a device to be cranked via the crank interface. Two or three handle-attachment points are preferable.

The handle-attachment points may be holes drilled through the body. The crank body may be a tube with the holes lined with a sleeve for easy insertion of the handle assembly.

The axle may be equipped with various stops or retaining features to help position and locate the bearings and handle on the axle, as well as to position the axle when inserted into a handle-attachment point. The axle may be a quick-release pin with a locking feature that resists removal of the axle from the attachment point.

The crank interface may be a clevis or a tubular end section and may have a hole adapted to receive a locking pin.

The crank assembly may have a solid rod for the crank body. The longer end of the crank body may include a second shorter end resulting in an S-shaped crank body. The second shorter end may be the one and only one handle-attachment point, and it may be adapted to be the axle of the crank handle assembly.

The crank assembly may be used with (or include) an adapter having a first end adapted to be driven by the crank interface of the crank assembly and a second end adapted to drive the device to be cranked.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a perspective view of an embodiment of the crank assembly;

FIG. 2 is an exploded view of an embodiment of the crank handle assembly;

FIG. 3 is a perspective view of another embodiment of the crank body assembly;

FIG. 4 is a perspective view of another embodiment of the crank interface;

FIG. 5 is a side elevation of another embodiment of the invention;

FIG. 6 is perspective exploded view of another embodiment of the invention;

FIG. 7 is an illustration of a use of an adapter with the embodiment of FIG. 5;

FIG. 8 is an end view of an adapter according to an embodiment of the invention;

FIG. 9 is a cross section of the adapter of FIG. 8;

FIG. 10 is a cross section of another embodiment of an adapter according to an embodiment of the invention;

FIG. 11 is a front perspective view of an embodiment of the invention;

FIG. 12 is a right side elevation view of the embodiment of FIG. 11;

FIG. 13 is a front elevation view of the embodiment of FIG. 11;

FIG. 14 is a rear elevation view of the embodiment of FIG. 11;

FIG. 15 is a right side elevation view of the embodiment of FIG. 11 in an alternate configuration;

FIG. 16 is a top plan view of the embodiment of FIG. 11; and

FIG. 17 is a bottom plan view of the embodiment of FIG. 11.

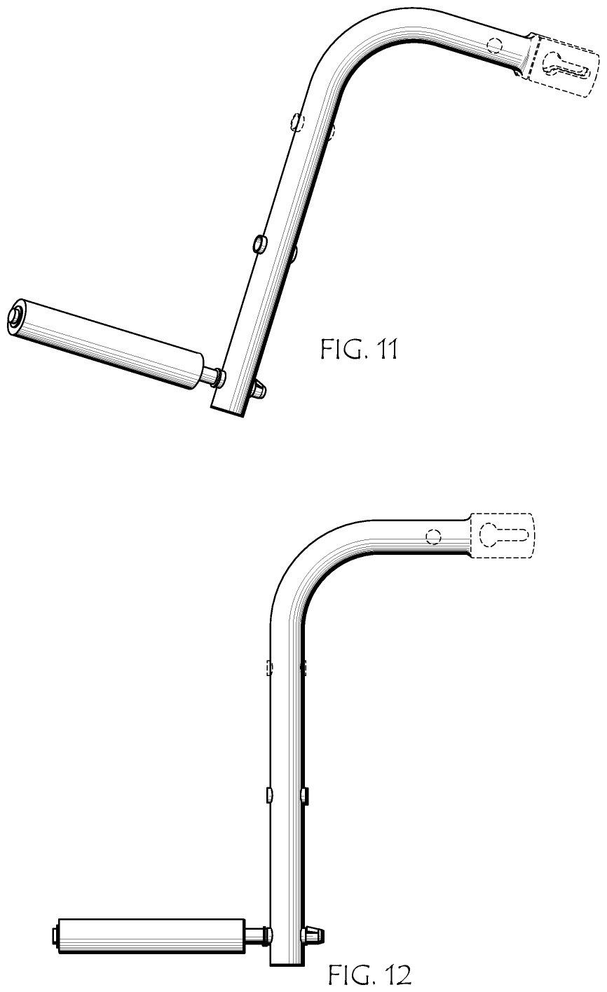

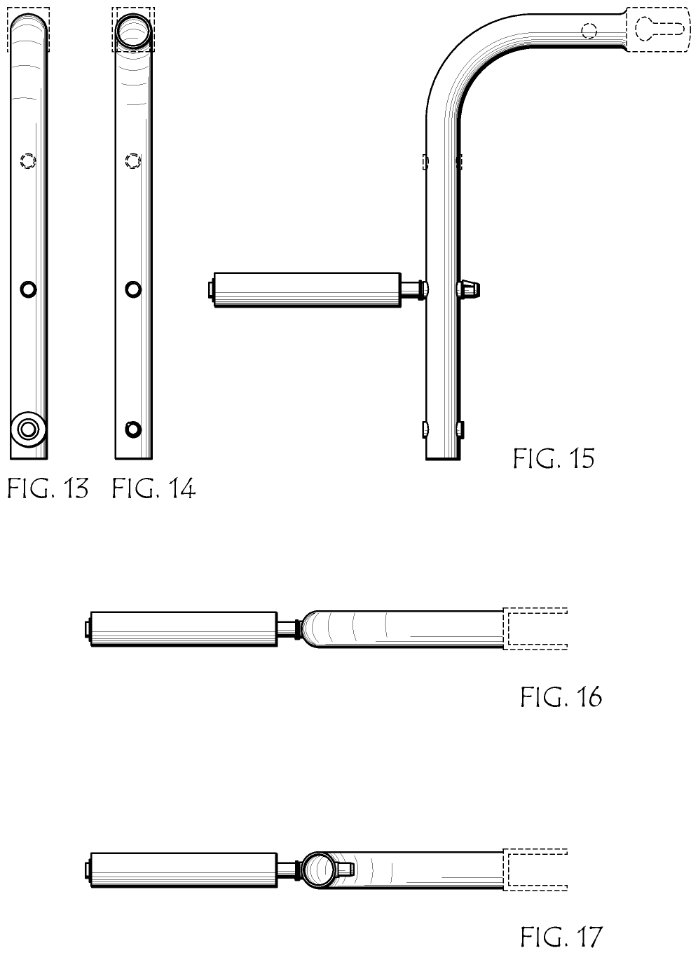

In FIGS. 11-17, a left side view would be the mirror image of the right side view of FIG. 12, and broken lines represent environmental structure or boundaries that are optional or variable.

### DETAILED DESCRIPTION

The present invention is directed to a crank with repositionable bearing handle and also to an associated crank adapter.

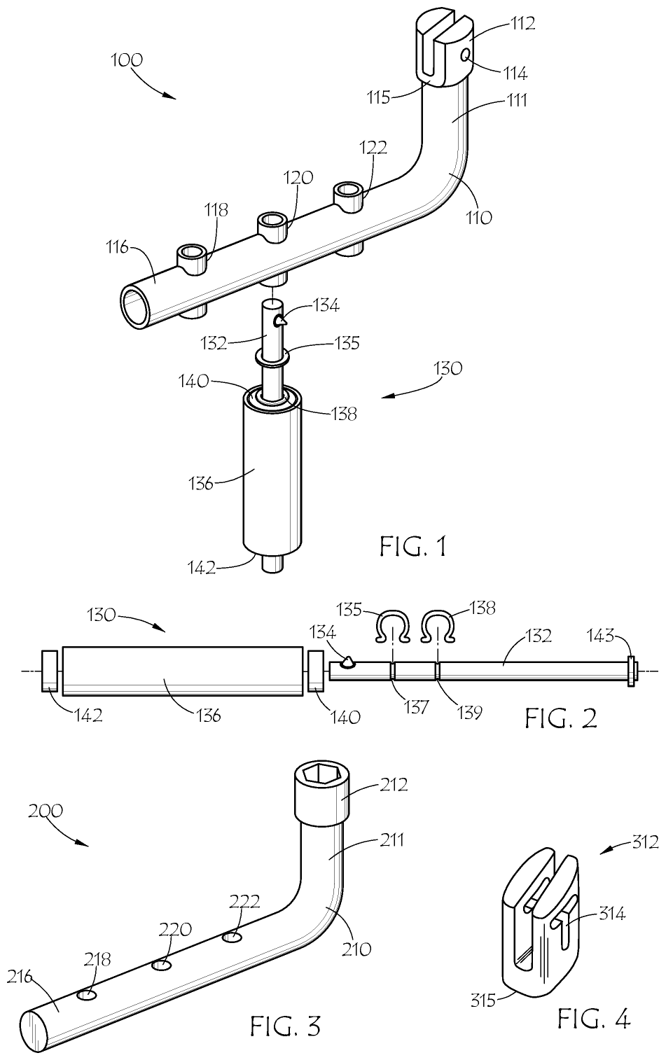

In one embodiment, shown in FIG. 1 and FIG. 2, crank assembly 100 is made up of the following components: tubular L-shaped crank body 110, clevis-style crank interface 112, three position-adjustment sleeves 118, 120, and 122, and crank handle assembly 130. The clevis 112 may be rigidly attached at 115, for example by welding, to the shorter arm 111 of the L-shaped crank body 110. The three sleeves (118, 120, and 122) may be fit into three holes drilled in the longer arm 116 of the L-shaped crank body 110. The handle assembly may be removably mounted in any of the three sleeves. The holes and sleeves may be located at a desired interval or spacing, making the handle position adjustable. The three sleeves may be inserted and fastened into the three holes.

Handle assembly 130 includes axle shaft or axle pin 132, two sealed bearings 140 and 142, two stops or retainers 135 and 138 (shown as snap rings or C-clips), and handle 136. The handle may have internal stops or shoulders to locate the bearings in proper place and prevent the handle sliding off the bearings. The axle pin 132 shown is a self-locking, quick-release pin which includes self-locking feature 134 in the form of a strong, spring-loaded plunger that functions as an easy insertion ramp. The plunger retracts when inserted, then springs back up when through the joined material (e.g., through sleeve 118). The vertical face at the rear of the plunger prevents backing out and locks the handle into place. To remove the handle you use a finger or a hand tool to compress the spring-loaded plunger and at the same time pull the handle out. An exemplary pin locking mechanism is sold under the trademark “SLIC Pin” by Pivot Point Inc. and is described in U.S. Pat. Nos. 6,872,039 and 7,147,420, the contents of which are hereby incorporated herein by reference.

The axle pin is customized to include means for spacing and retaining the bearings, including groove 137 for snap ring 135 and groove 139 for snap ring 138. Pin 132 also includes end stop 143, which may be another snap ring and groove, or a permanently attached ring, cap nut, protrusion with washer, or a machined, integral shoulder. The two sealed bearings 140 and 142 are pressed onto pin 132 and into crank handle 136. The two retaining snap rings are placed into the grooves on the pin. If stop 143 is permanent, the bearings would be mounted from the opposite end of the axle. Alternately, the bearings could be mounted from the end opposite the locking feature followed by attaching stop 143 to retain the handle, in which case stops 135 and/or 138 may be permanently mounted on the axle. The stop 143 could be a clip and groove design, a cap nut, a retaining ring and cap, an acorn nut, a threaded fastener, or the like. The handle assembly 130 is then ready to be inserted into the one of the sleeves in the position of choice in the crank body. The handle can spin freely and easily on the axle pin due to the bearings. The retainers or stops permit snug attachment of the handle assembly to the crank body and a suitable distance between handle and crank body for safe and easy hand cranking. Thus, the first stop, or insertion stop 135, limits the insertion of the axle into the crank body. The second stop, bearing stop 138, is spaced from the first stop 135 and defines the position of the first bearing 140. The third stop 143 keeps the second bearing 142 and thus the handle on the axle. The handle assembly may be easily removed and stowed away when the crank is not in use.

In other embodiments, the crank assembly may have a number of variations, additional features, or alternatives. Optional features for the crank body include materials, textures, and coatings, including but not limited to: machined or formed; stainless steel, aluminum or other strong material; square tubing, thicker- or thinner-walled tubing, or solid rod; and painted, powder coated, anodized, or uncoated finishes. The L-shape may be a 90-degree bend. Alternately, the bend could be a compound bend that provides a desired reach, stand-off, and turn radius while maintaining the desired handle assembly angle.

The crank interface may be designed for engagement with any desired jack, lift, or device requiring hand cranking. The interface may be, but is not limited to being, laser cut, punched, plasma cut, bent into its shape, punched into its shape, molded, machined into its shape, and the like. The crank interface may be attached to the crank body by welding, threaded attachment, press fit or the like. The crank interface may be integrally formed at the end of the crank body by cutting, machining, bending and/or combinations thereof. The crank interface may make the crank easily removable from the equipment being cranked, for example a clevis combined with a suitable clevis pin. Any desired style of clevis pin may be used with the crank interface, or no clevis pin if the interface positively locks with the device to be cranked. Alternately, the crank interface may be the short end of the tubular crank body itself, preferably with a suitably located through hole for use with a locking pin such as a clevis pin.

As an example, the embodiment crank assembly 200 shown in FIG. 3 includes solid crank body 210 with through holes 218, 220, and 222 in the longer end 216, and socket-style crank engagement 212 on the shorter end 211. Any of the handle assemblies described herein could be used with crank assembly 200. Any of the other variations described herein could also be applied to crank assembly 200 or to other embodiments.

FIG. 4 shows an alternative clevis-style crank interface 312 which may be attached at 315. This one includes T-shaped slots 314 instead of the round holes 114 of the embodiment of FIG. 1.

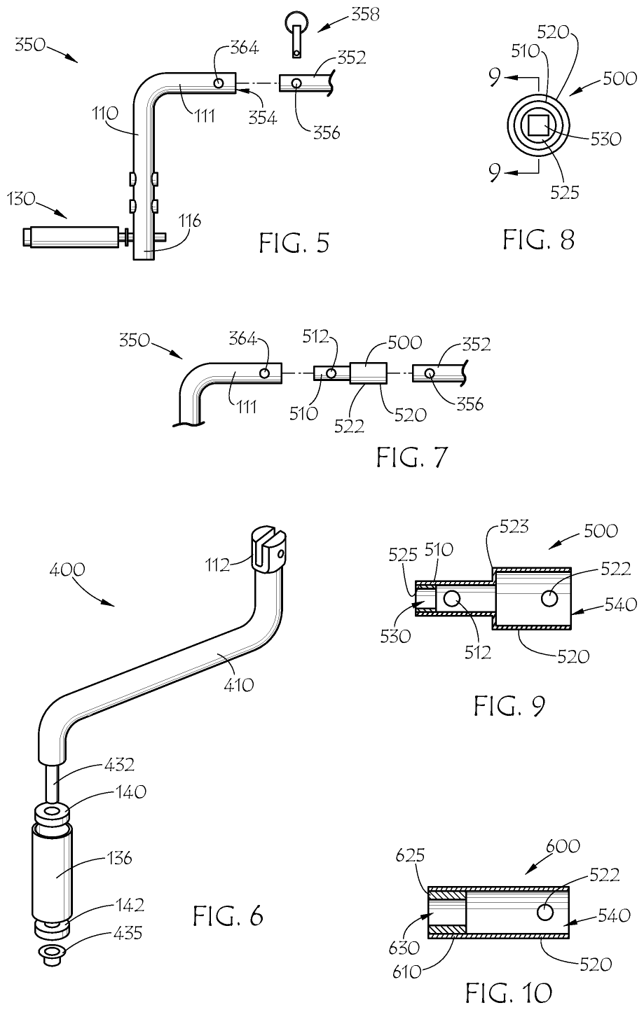

As an example which does not use a clevis, FIG. 5 shows a crank interface that is integral with the tube end for a direct connection with a crankable device. In FIG. 5, crank assembly 350 includes tubular crank body 110 and handle assembly 130 on the longer arm 116 as in the first embodiment. The shorter arm 111 has open end 354 sized to slide over the crankable attachment point 352 of a jack or lift (not shown). Arm 111 includes through-hole 364 located to align with through-hole 356 of typical crankable attachment point 352 for insertion of retaining pin 358.

The handle may also have various handle materials, textures, and coating options, including but not limited to machined, knurled, grooved, anodized, painted, powder coated, uncoated, stainless, aluminum. The handle may be made of metal, plastic, thermoset, or composite material. The handle assembly may also use other style pins or rods for the handle axle as well as other handle axle locking or retaining methods or stops. The position of the retaining features or stops are also adjustable for various applications. The end of the crank body may be left open or plugged with but not limited to, plastic plug, metal plug, aluminum plug, welded, pressed, or threaded into place. The bearings may also be of different styles including but not limited to sealed, unsealed, ball bearing, needle bearing, plastic bearing, and the like.

The invention may use other styles of pins or shafts for the handle axle, such as detent ball pins, clevis pins, wire lock pins, tab lock pins and the like. Detent ball pins may use a spring-loaded ball instead of the ramp plunger described above as the locking feature. Other pins such as clevis pins may use a cotter, ring, or the like as the locking feature. The essential aspect of the locking feature is that is provides a degree of resistance to removal of the axle pin from the crank body while still allowing the handle assembly to be easily removably positioned or inserted in any of the attachment points in the crank body.

The sleeves may be fastened into the crank body by welding, crimping, interference fitting, or press fitting, and the like. Sleeves may not be needed with a solid crank body.

This device also may be built without the multiple position adjustable sleeves making it a single-position crank with a bearing handle. Any desired plurality or number of positions from one or more, or two or more, or three or more, may be included. The style and material of the position adjustable sleeves may also be optional but not limited to aluminum, stainless steel, copper. The method of fastening the sleeves may also be optional but not limited to welding, friction welding, pressing, crimping. If built without a multiple position adjustable handle the crank body design may change to accommodate a second bend at the longer end of the L-shape resulting in a S-shaped handle body which could then accommodate a permanent handle-axle rod or pin on which to place the bearings and press the handle over the bearings. The second bend could be a 90-degree bend, or any other suitable angle resulting in a second short end on the crank body. FIG. 6 shows such an embodiment. In FIG. 6, crank assembly 400 includes S-shaped crank body 410 with crank interface 112 at one end and crank handle axle 432 machined into (or welded to or otherwise attached to) the opposite end, i.e., the second shorter end. Bearings 140 and 142 may then be slid onto pin 432 and handle 136 may be pressed over bearings 140 and 142. Of course, clips, shoulders, grooves, stops, retainers, or other features such as cap nut 435 may be included if desired.

It may be desirable for the crank handle to be adaptable to a variety of jack attachment points. For this purpose, an adapter may be included with the crank handle. FIG. 7 illustrates the use of such an adapter. Adapter 500 is a tubular body with a first end 510 which is adapted to mate with the interface of handle assembly 350. Thus, crank handle end 111 may slide over first adapter end 510, aligning holes 364 and 512 so that a pin (such as clevis pin 358) can be inserted. Shoulder 523 may be included to limit insertion of the axle into the crank body and for easier alignment of the holes. Adapter 500 also has a second end 520 which is adapted to engage the desired jack attachment point. In this case, opening 540 at second end 520 fits over exemplary crankable attachment point 352 so that hole 522 aligns with hole 356. FIG. 8 is an end view from the first end 510. This embodiment includes insert 525 with wrenching feature 530 in the form of a square-drive recess or hole. FIG. 9 shows a longitudinal, cross-section view of adapter 500. The insert 525 could be press fit, welded, crimped, or integrally machined to fix it in the first end 510.

The wrenching feature 530 could be adapted for any other desired style of wrench or drive, such as a square drive, hex drive, star drive, either as the appropriate hole shape or as a protrusion for a matching socket drive. The wrenching feature could thus be used to drive the jack or lift with a power tool instead of by hand. This may be advantageous if it is desired to operate the jack very quickly, for example under a no-load condition. With quick release pins and tools, one can quickly switch between the power drive and the crank handle as desired.

FIG. 10 illustrates another embodiment of the adapter that could be used with a power tool instead of by hand. It could also be used with a crank assembly having a suitable crank interface. In FIG. 10, adapter 600 is a tubular body with a first end 610 with insert 625 which defines wrenching feature 625, which may be an opening or a protrusion which is adapted to mate with any desired style of wrench or drive. Adapter 600 also has a second end 520 which is adapted to engage the desired jack attachment point. In this case, opening 540 at second end 520 includes hole 522 which may be used for a clevis pin. The second end 520 of either embodiment of the adapter may be shaped, machined, equipped in any desired way to provide a crank interface for adapting to a power tool to operate the device being cranked.

The disclosed device is unique when compared with other known devices and solutions because it provides: (1) a crank body that has multiple sleeved holes serving as receivers to the handle making it a multiple handle-position crank body; (2) a special axle pin such as a self-locking, quick-release pin used for the handle axle and bearings pressed thereon with the handle pressed over the bearings resulting in very smooth operation and greater ease of use; (3) a handle assembly that can be inserted into one of the multiple-position sleeved holes of choice in the crank body; and (4) a convenient adapter. The handle assembly may be inserted into the sleeve or hole that is the shortest distance from the center of the turning radius, thus providing a shorter rotating radius to achieve a quicker operation. Likewise, the handle assembly may be inserted into one of the sleeves or holes that is a longer distance from the center of the turning radius to provide a longer rotating radius to make it easier to crank a greater load with less effort.

This design solves problems associated with conventional cranks. The bearings provide much lower friction and easier operation under load than cranks without bearings. The adjustability results in faster operation of the crank when without load. With sealed bearings, the handle assembly is not susceptible to foreign matter, making it a low-maintenance solution. If plastic handles are not durable enough, metal handles may be used in the present invention. The handles may be textured, coated, etc., so there is great flexibility of design. Metal construction may ensure toughness to wear and weather elements. A metal handle may be textured more aggressively to ensure a firm grip and a longer-lasting texture.

Furthermore, the handle itself is completely removable and could easily be stowed away when the crank is not in use further preserving it from unwanted exposure to the weather elements and even serving as a theft deterrent of a trailer when used in that application.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

1. A crank assembly comprising:
a crank body that is L-shaped with a shorter end and a longer end;
a crank interface attached to the shorter end;
at least one handle-attachment point on the longer end;
a crank handle assembly comprising: an axle; one or more bearings mountable on the axle; and a handle mountable over the bearings; and
wherein the crank handle assembly is removably positionable on the at least one handle-attachment point for operation of the crank assembly.

2. The crank assembly of claim 1 comprising two or more of the handle-attachment points spaced apart on the longer end.

3. The crank assembly of claim 2 wherein each of the handle-attachment points comprises a hole through the crank body and adapted to receive a first end of the axle.

4. The crank assembly of claim 3 wherein the crank body comprises a tube and the handle-attachment points further comprise a sleeve fit into each said hole whereby the hole is adapted to receive the first end of the axle.

5. The crank assembly of claim 1 wherein the axle comprises a quick-release pin with a locking feature that resists removal of the axle from the attachment point.

6. The crank assembly of claim 5 wherein the axle comprises a self-locking, quick-release pin.

7. The crank assembly of claim 5 wherein the handle assembly further comprises a first retaining feature that limits insertion of the axle in the crank body.

8. The crank assembly of claim 7 wherein the handle assembly further comprises a second retaining feature that positions the handle a predetermined distance from the first retaining feature and the crank body.

9. The crank assembly of claim 8 wherein the handle assembly further comprises a third retaining feature that locks the handle onto the axle.

10. The crank assembly of claim 1 wherein the crank interface comprises a clevis.

11. The crank assembly of claim 1 wherein the crank interface comprises a tubular end section and a transverse interface hole adapted to receive a clevis pin.

12. The crank assembly of claim 11 further comprising an adapter comprising: a first end adapted for insertion into the tubular end section; a first transverse adapter hole adapted to align with the interface hole and receive the clevis pin; and a second end with a second crank interface.

13. The crank assembly of claim 1 wherein the crank body comprises a solid rod.

14. The crank assembly of claim 13 wherein the longer end of the crank body further comprises a second shorter end resulting in an S-shaped crank body; and wherein the second shorter end comprises the one and only one said handle-attachment point.

15. The crank assembly of claim 14 wherein the second shorter end is adapted to be the axle of the crank handle assembly.

16. A crank adapter comprising a tubular body with a first end and a second end; the first end comprising an insert fixed therein and having a wrenching feature; the second end adapted to slide over a jack crank attachment point and comprising a first transverse hole adapted to align with a similar hole on a crank attachment point of a device to be cranked and to receive a locking pin.

17. The crank adapter of claim 16 further comprising a second transverse hole at the first end for receiving a locking pin.

18. The crank adapter of claim 16 further comprising a shoulder for limiting the insertion of the first end into an end of a tubular crank device.

19. A crank assembly comprising:
a crank body that is L-shaped with a shorter end and a longer end;
a crank interface located at the shorter end;
a plurality of handle-attachment points on the longer end;
a crank handle assembly comprising: a self-locking, quick-release axle pin with an insertion stop near a first end; two bearings mounted on the axle pin; and a handle mounted over the bearings; a bearing stop on the axle pin spaced from the insertion stop; and a handle retainer mounted on the other end of the axle pin;
wherein the crank handle assembly is removably insertable at any of the handle-attachment points for operation of the crank assembly.

20. The crank assembly of claim 19 wherein the crank body comprises a tube and each of the handle-attachment points comprise a transverse through hole with a sleeve fit into each said hole, whereby the hole is adapted to receive the first end of the axle.

21. The crank assembly of claim 1 wherein the longer end of the crank body further comprises a second shorter end resulting in an S-shaped crank body; and wherein the second shorter end comprises the one and only one said handle-attachment point.

22. The crank assembly of claim 21 wherein the second shorter end comprises the axle of the crank handle assembly.
